(19) United States
(12) Patent Application Publication
(10) Pub. No.: US 2021/0060842 A1
(43) Pub. Date: Mar. 4, 2021

(54) LUBRICANT PUMP DEVICE AND METHOD OF OPERATING THE SAME

(71) Applicant: HANSUNG PRECISION CO., LTD

(72) Inventor: Chang Sun KIM, Incheon (KR)

(21) Appl. No.: 16/962,344

(22) PCT Filed: Oct. 30, 2019
(86) PCT No.: PCT/KR2019/014443

§ 371 Date: Jul. 15, 2020

(30) Foreign Application Priority Data
Sep. 4, 2019 (KR) 10-2019-0109701

(51) Int. Cl. B29C 45/83; B29C 45/80

(52) U.S. Cl. CPC B29C 45/83; B29C 45/80

(57) ABSTRACT

A lubricant pump device includes a lubricant cartridge having a tank in which a lubricant is accommodated, and a pump body which is coupled to the lubricant cartridge and receives the lubricant from the lubricant cartridge, wherein the pump body includes a suction path into which the lubricant accommodated in the tank is introduced, a discharge path through which the lubricant introduced from the suction path is supplied to a lubricant path, a temporary storage path disposed between the suction path and the discharge path, a pressure detector provided at one side of the discharge path and configured to measure an internal pressure of the discharge path, and a lubricant supply controller including a cylinder communicating with the temporary storage path and a piston accommodated in the cylinder and moved forward and backward in a longitudinal direction of the cylinder.

### CROSS-REFERENCE TO RELATED APPLICATION

This application claims priority to and the benefit of Korean Patent Application No. 2019-0109701, filed on Sep. 4, 2019, the disclosure of which is incorporated herein by reference in its entirety.

### BACKGROUND

### 1. Field of the Invention

The present invention relates to a lubricant pump device and a method of operating the same, and more specifically, to a lubricant pump device including a position detector which has a simple structure and is applicable to various products having different specifications and a method of operating the same.

### 2. Discussion of Related Art

Generally, lubricant pump devices are formed to provide lubricants to apparatuses such as injection molders configured to inject resins or metals.

FIG. 1 is a front cross-sectional view illustrating a conventional lubricant pump device, FIG. 2 is a plan cross-sectional view and a front cross-sectional view which illustrate main portions of the lubricant pump device of FIG. 1, and FIG. 3 is a view illustrating an operating state of the conventional lubricant pump device. FIG. 3 is divided into FIGS. 3A to 3C according to a position of a piston.

As shown in FIGS. 1 to 3, a conventional lubricant pump device S includes a position detector 61 including a first detector K1, a second detector K2, and a third detector K3.

The first detector K1, the second detector K2, and the third detector K3 included in the position detector 61 are formed to detect a position of a piston 30. That is, the position detector 61 may detect whether the piston 30 is positioned at a first position P1, a second position P2, or a third position P3.

In other words, the first detector K1 to the third detector K3 provided in the position detector 61 are formed to detect a position of a magnet 60 provided in a connection member 47 coupled to a rear end portion of the piston 30 and moving with the piston 30 to detect a movement position of the piston 30.

The first detector K1, the second detector K2, and the third detector K3 may be Hall elements.

An operation process of the lubricant pump device S including the position detector 61 will be described below. In a case in which the piston 30 positioned at the third position P3 moves forward to the first position P1 due to normal rotation of motor 41, a lubricant accommodated in a temporary storage path t is supplied to a discharge path 14.

In addition, in a case in which the piston 30 positioned at the first position P1 moves backward to the second position P2 due to reverse rotation of the motor 41, a lubricant accommodated in a suction path 12 is introduced into the temporary storage path t.

In addition, in a case in which the piston 30 positioned at the second position P2 moves forward to the first position P1 due to the normal rotation of the motor 41, the lubricant accommodated in the temporary storage path t is supplied to the discharge path 14.

As described above, in the case in which the piston 30 reciprocally moves between the first position P1 and the second position P2, the lubricant accommodated in the suction path 12 may be supplied to the discharge path 14.

In addition, in a case in which a load current of the motor 41 is a predetermined load current or more during a process of detecting the load current of the motor 41, a controller 70 moves the piston 30 to the third position P3 to depressurize a pressure, which is increased to a predetermined pressure or more, in a lubricant path W.

In this case, a main purpose of the third detector K3 is to provide a stop signal of the motor 41 to the controller 70 in a case in which the third detector K3 recognizes the piston 30 which reaches the third position P3.

However, although an operation of the motor 41 stops in the state in which the third detector K3 recognizes the piston 30 at the third position P3, there is a problem in that the piston 30, which is moving toward the third position P3, may not exactly stop at a finally desired position due to an inertial force of the motor 41 according to a load deviation during the operation. That is, depressurization in the lubricant path W may not be precisely controlled at a movement position of the piston 30.

In addition, the position detector 61 provided in the lubricant pump device S is manufactured in a custom manner to match a size and a structure of a finally manufactured lubricant pump device S. That is, since the first detector K1, the second detector K2, and the third detector K3 are integrally fixed to the position detector 61 in a custom manner to match the size and the structure of the lubricant pump device S, there is a problem in that the position detector 61 may not be used in other lubricant pump devices S except the corresponding product.

In other words, for example, in a case in which fine adjustment of a position of the third position P3 is needed due to a change in size and structure of a lubricant pump device S, there is a problem in that the corresponding position detector 61 may not be applied to the lubricant pump device S in which adjustment of the position of the third position P3 is performed. That is, the corresponding position detector 61 cannot be applied to a product having a different specification.

In addition, since the position detector 61 necessarily includes the third detector K3, there are problems in that a structure is complicated and a manufacturing cost is also increased.

### SUMMARY OF THE INVENTION

The present invention is directed to providing a lubricant pump device including a position detector formed to be applicable to various products having different specifications and a method of operating the same.

According to an aspect of the present invention, there is provided a lubricant pump device including a lubricant cartridge including a tank in which a lubricant is accommodated, and a pump body which is coupled to the lubricant cartridge and receives the lubricant from the lubricant cartridge, wherein the pump body includes a suction path into which the lubricant accommodated in the tank is introduced, a discharge path through which the lubricant introduced from the suction path is supplied to a lubricant path, a temporary storage path disposed between the suction path and the discharge path, a pressure detector provided at one side of the discharge path and configured to measure an internal pressure of the discharge path, a lubricant supply controller including a cylinder communicating with the temporary storage path and a piston accommodated in the cylinder and moved forward and backward in a longitudinal direction of the cylinder, a controller configured to control an operation in a lubricant supply mode in which the lubricant of the suction path is guided to the discharge path and configured to control an operation in a lubricant depressurization mode in which the lubricant of the discharge path is guided to the suction path through a bypath, and a position detector including a first detector for detecting a first position of the piston to supply a lubricant accommodated in the temporary storage path to the discharge path and a second detector configured to detect a second position of the piston moved backward from the first position to introduce the lubricant accommodated in the suction path into the temporary storage path, and the controller derives a movement speed of the piston on the basis of a movement time of the piston moved from the first position to the second position in the lubricant depressurization mode and calculates a movement time of the piston to a depressurization position, to which the piston moves, on the basis of the derived movement speed of the piston to control movement of the piston.

The controller may include a first storage in which information about a first distance between the first detector and the second detector is stored, a second storage in which information about a second distance between the second detector and the depressurization position is stored, and an operation part configured to calculate the movement time and the movement speed of the piston, wherein the second distance may be selectively adjustable by a user.

The controller may control the lubricant supply controller in the lubricant depressurization mode in a case in which an internal pressure of the discharge path transmitted from the pressure detector is a predetermined pressure value or more.

The lubricant supply controller may further include a motor which is normally and reversely rotatable, a decelerator which decreases a rotational speed transmitted from the motor, a screw shaft which receives power from the decelerator and is rotated, a connection member fixed to a rear end portion of the piston and moving the piston forward and backward according to rotation of the screw shaft, and a guide shaft formed to be parallel to the screw shaft and configured to guide a movement direction of the connection member.

The lubricant pump device may further include a stopper fixedly coupled to an outer side of a deceleration casing protecting the decelerator and configured to restrict movement of the connection member, wherein the stopper may include a fixed member which has one end portion coupled to the deceleration casing and in which a hollow hole into which an end portion of the guide shaft is inserted is formed, and a flange member protruding outward from the other end portion of the fixed member.

The lubricant pump device may further include an inlet check valve disposed between the suction path and the temporary storage path, and an outlet check valve disposed between the temporary storage path and the discharge path, wherein the bypath may include a first pressure relief path through which the suction path communicates with the cylinder, and a second pressure relief path through which the discharge path communicates with the cylinder.

According to an aspect of the present invention, there is provided a method of operating a lubricant pump device including the steps of (A) in a case in which an internal pressure of a discharge path, which is transmitted from a pressure detector, is a predetermined pressure value or more, transmitting a stop command signal from the pressure detector to a controller, and (B) when the controller receives the stop command signal from the pressure detector, controlling a lubricant supply controller to a lubricant depressurization mode.

The step (B) may include the steps of (B1) detecting, by a first detector, a piston at a first position, (B2) moving the piston to a second position, (B3) detecting, by a second detector, the piston which is being moved, (B4) calculating a movement speed of the piston using a movement time of the piston moved a first distance at a time point at which the second detector recognizes the piston, (B5) calculating a movement time of the piston to a predetermined depressurization position, to which the piston moves, on the basis of the calculated movement speed of the piston, and (B6) moving the piston for the calculated movement time of the piston to the depressurization position to which the piston moves.

A distance from the second detector to the depressurization position may be selectively adjustable by a user.

In the lubricant depressurization mode, the movement speed of the piston may be less than a movement speed of the piston in a lubricant supply mode.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a front cross-sectional view illustrating a conventional lubricant pump device;

FIG. 2 is a plan cross-sectional view and a front cross-sectional view which illustrate main portions of the lubricant pump device of FIG. 1;

FIG. 3 is a view illustrating an operating state of the conventional lubricant pump device;

FIG. 4 is a front cross-sectional view illustrating a lubricant pump device according to one embodiment of the present invention;

FIG. 5 is an exemplary view illustrating a state in which a piston is positioned at a first position according to one embodiment of the present invention;

FIG. 6 is an exemplary view illustrating a state in which the piston is positioned at a second position according to one embodiment of the present invention;

FIG. 7 is an exemplary view illustrating a state in which the piston is positioned at a depressurization position according to one embodiment of the present invention;

FIG. 8 is a schematic exemplary view illustrating a position detector according to one embodiment of the present invention;

FIG. 9 is a flowchart illustrating an operation process of the lubricant pump device according to one embodiment of the present invention; and

FIG. 10 is a flowchart illustrating an operation process in which a lubricant supply controller is switched to a depressurization mode according to one embodiment of the present invention.

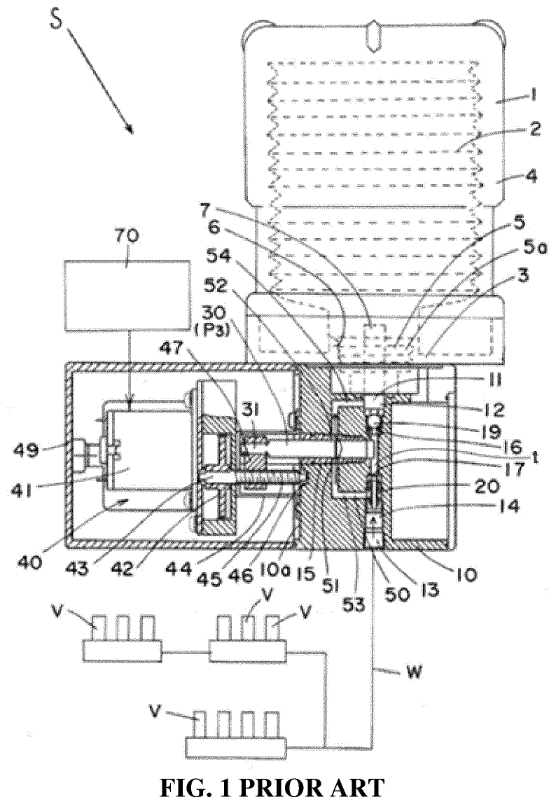

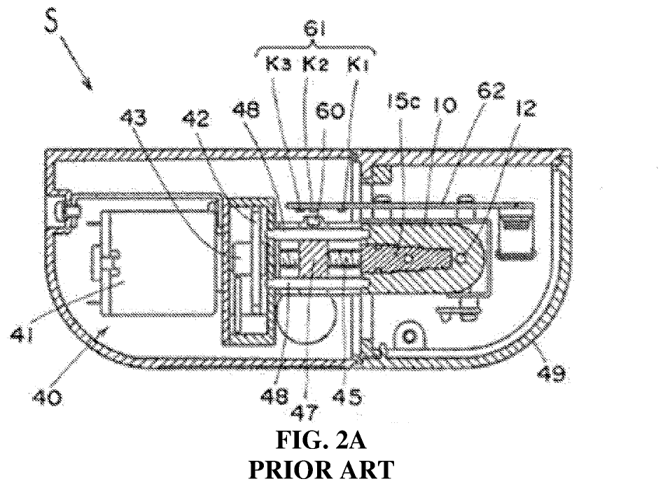

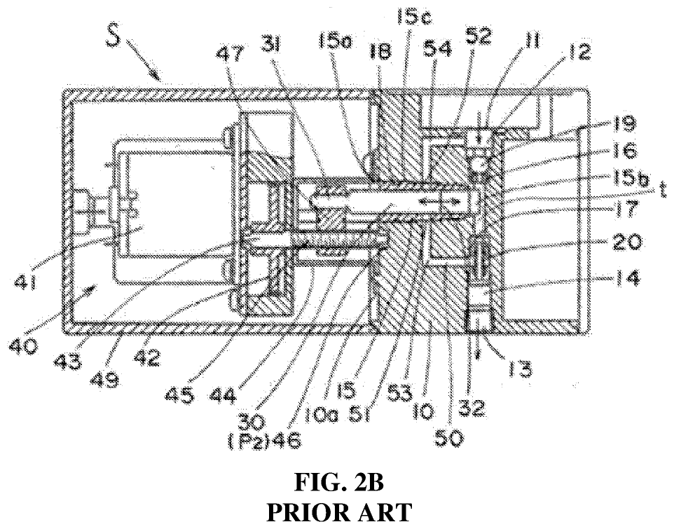

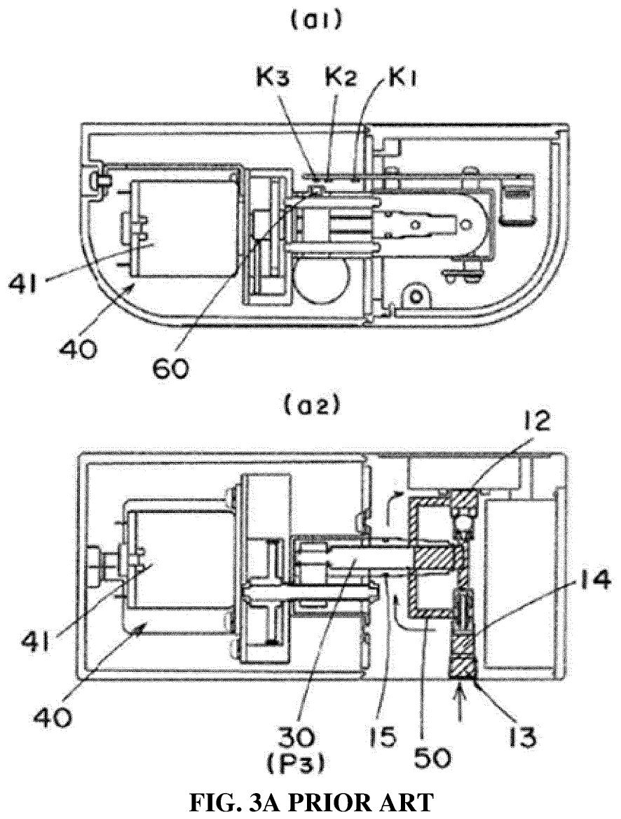

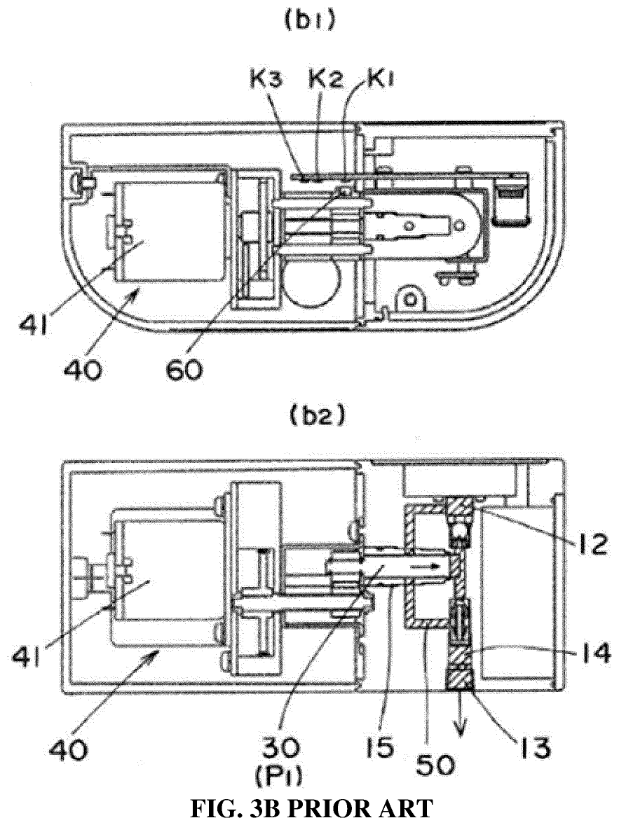

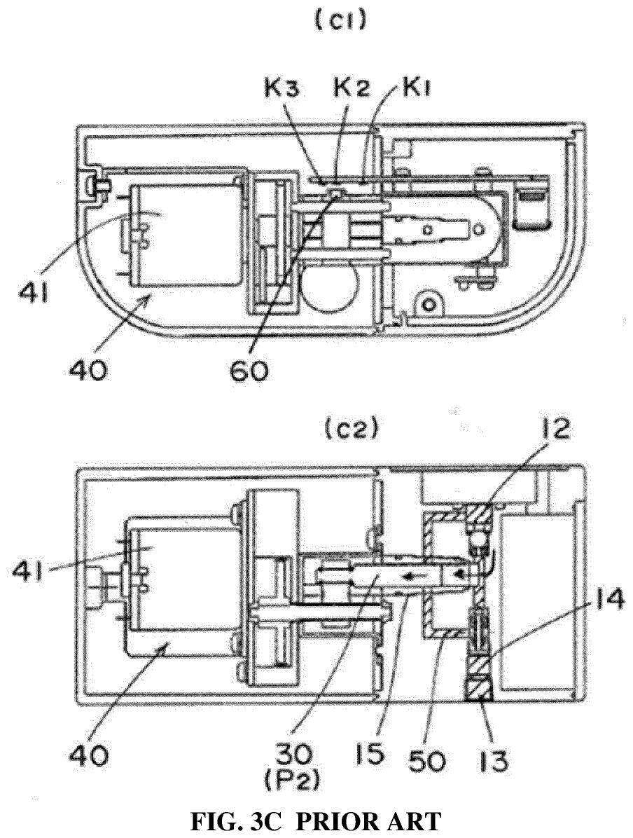

### DETAILED DESCRIPTION OF EXEMPLARY EMBODIMENTS

Hereinafter, the present invention will be described in detail with reference to the accompanying drawings. However, various embodiments of the present invention may be implemented in several different forms and are not limited to embodiments described herein. In addition, parts irrelevant to descriptions are omitted in the drawings in order to clearly explain the present invention, and the similar parts are denoted by the similar reference numerals throughout this specification.

Throughout this specification, when a part is referred to as being “connected” to another part, it includes “directly connected” and “indirectly connected” via an intervening part. Also, when a certain part “includes” a certain component, this does not exclude other components unless explicitly described otherwise, and other components may in fact be included.

In the present invention, “on” and “under” refer to being positioned on or under a target member and do not necessarily mean being positioned on or under the target based on a direction of gravity.

Hereinafter, embodiments of the present invention will be described in detail with reference to the accompanying drawings.

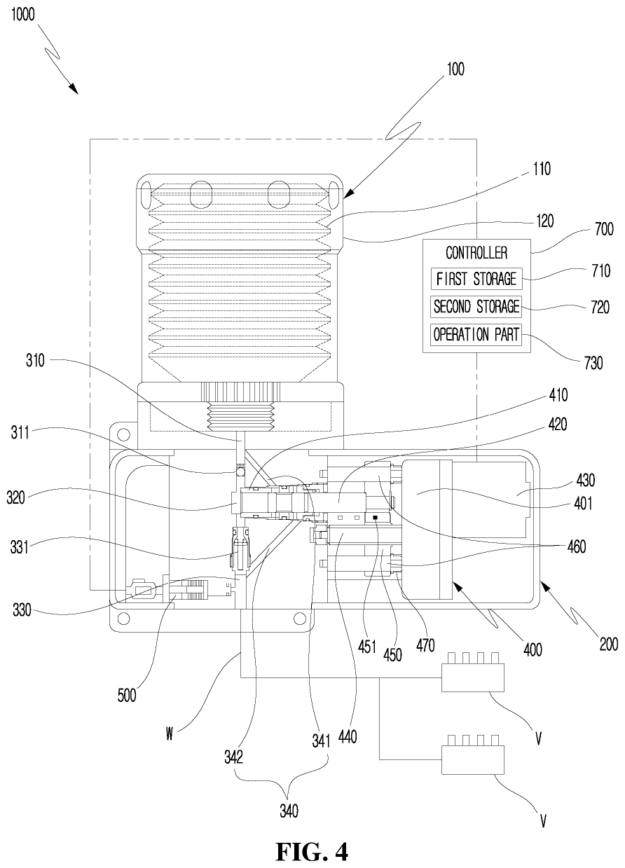

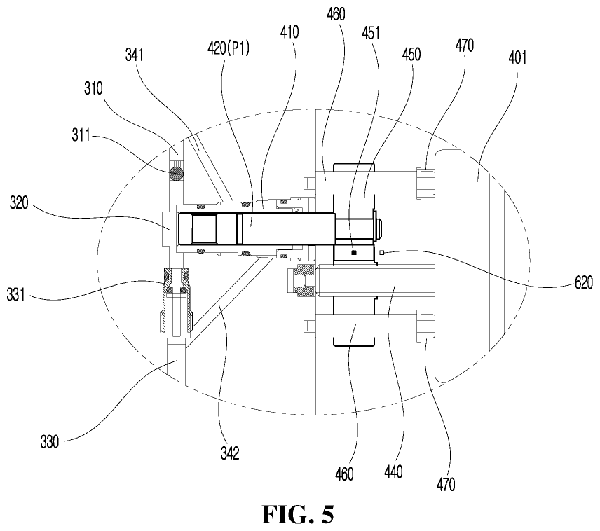

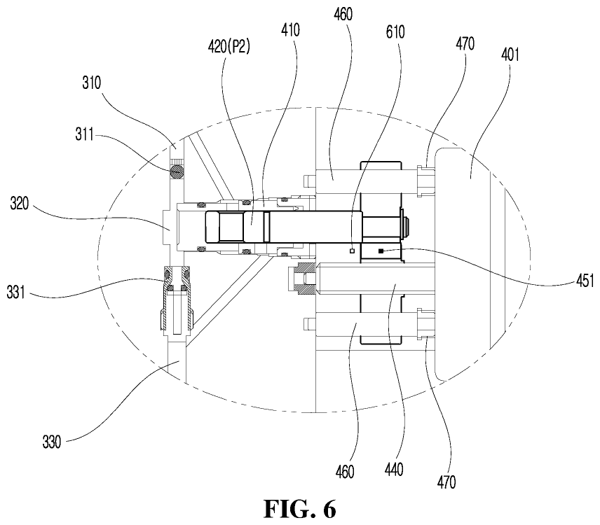

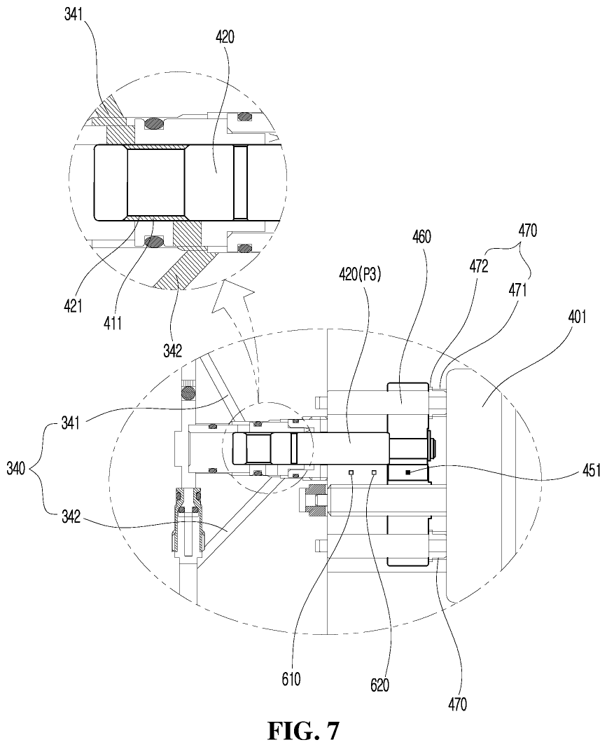

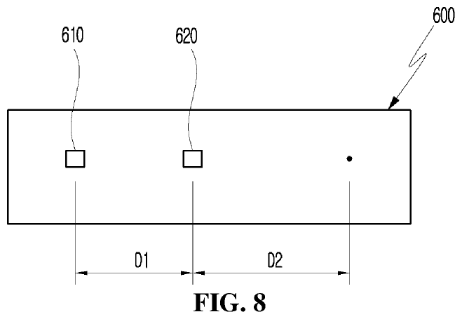

FIG. 4 is a front cross-sectional view illustrating a lubricant pump device according to one embodiment of the present invention, FIG. 5 is an exemplary view illustrating a state in which a piston is positioned at a first position according to one embodiment of the present invention, FIG. 6 is an exemplary view illustrating a state in which the piston is positioned at a second position according to one embodiment of the present invention, FIG. 7 is an exemplary view illustrating a state in which the piston is positioned at a depressurization position according to one embodiment of the present invention, and FIG. 8 is a schematic exemplary view illustrating a position detector according to one embodiment of the present invention;

As shown in FIGS. 4 to 8, a lubricant pump device 1000 may include a lubricant cartridge 100 and a pump body 200.

The lubricant cartridge 100 is formed to be attachable to and detachable from the pump body 200.

The lubricant cartridge 100 may include a tank 110 and a cover 120.

In this case, a lubricant may be accommodated in the tank 110, and the lubricant accommodated in the tank 110 may be supplied to the pump body 200.

The tank 110 may be a cartridge container which is flexible in an axial direction of the tank 110.

A male screw formed on a lower portion of the tank 110 is screw-coupled to a female screw formed in an upper portion of the pump body 200.

In addition, the cover 120 is provided outside the tank 110 and formed to protect the tank 110 from the outside.

Meanwhile, the pump body 200 is formed to receive a lubricant from the lubricant cartridge 100 and supply the lubricant to a lubricant path W connected to a valve V.

The pump body 200 may include a suction path 310, a temporary storage path 320, a discharge path 330, a bypath 340, a lubricant supply controller 400, a pressure detector 500, a position detector 600, and a controller 700.

In this case, the suction path 310, the temporary storage path 320, the discharge path 330, and the bypath 340 may be flow pipe paths through which a lubricant moves.

The suction path 310 is disposed in an upper portion of the pump body 200. The lubricant accommodated in the tank 110 may be introduced into the suction path 310.

An inlet check valve 311 is provided on a lower end portion of the suction path 310. That is, the inlet check valve 311 is provided on the suction path 310 and disposed between the suction path 310 and the temporary storage path 320.

The inlet check valve 311 prevents a lubricant supplied from the suction path 310 to the temporary storage path 320 from moving backward to the suction path 310.

In addition, the temporary storage path 320 is disposed under the suction path 310. The temporary storage path 320 is formed to communicate with a cylinder 410 provided in the lubricant supply controller 400.

In addition, a piston 420 moving in a longitudinal direction of the cylinder 410 is provided in the cylinder 410. The piston 420 moves forward and backward in a state in which the piston 420 is accommodated in the cylinder 410.

Due to the forward and backward movement of the piston 420, a lubricant accommodated in the suction path 310 may be supplied to the temporary storage path 320, a lubricant accommodated in the temporary storage path 320 may be supplied to the discharge path 330, or a lubricant accommodated in the discharge path 330 may be supplied to the suction path 310 through the bypath 340.

In this case, the discharge path 330 is disposed under the temporary storage path 320.

The discharge path 330 may communicate with the lubricant path W, and thus a lubricant introduced into the discharge path 330 may be supplied to the lubricant path W.

An outlet check valve 331 is provided on an upper end portion of the discharge path 330. That is, the outlet check valve 331 is provided on the discharge path 330 and disposed between the discharge path 330 and the temporary storage path 320.

The outlet check valve 331 prevents a lubricant supplied from the temporary storage path 320 to the discharge path 330 from moving backward to the discharge path 330.

As described above, the lubricant supply controller 400 configured to move a lubricant may include the cylinder 410, the piston 420, a motor 430, a decelerator (not shown), a screw shaft 440, a connection member 450, guide shafts 460, and stoppers 470.

The motor 430 is formed to be normally and reversely rotatable.

The piston 420 may move forward or backward according to a rotating direction of the motor 430.

In addition, the motor 430 is connected to the decelerator. The decelerator is formed to decrease a rotational speed transmitted from the motor 430. The decelerator may be formed as a plurality of connected gears, and gears provide in the motor 430 may be engaged with the gears provided in the decelerator.

In addition, the screw shaft 440 is formed to be connected to the decelerator and receive power from the decelerator. That is, a gear provided on one end portion of the screw shaft 440 is engaged with the gear provided on the decelerator so that rotational power of the decelerator may be transmitted to the screw shaft 440.

In addition, the connection member 450 is coupled to the screw shaft 440 and formed to move forward or backward according to a rotating direction of the screw shaft 440. That is, the connection member 450 is slidably supported by two guide shafts 460 and moves forward and backward according to normal and reverse rotation of the screw shaft 440.

In this case, the guide shaft 460 is provided to be parallel to the screw shaft 440 and guides a movement direction of the connection member 450. That is, the guide shaft 460 allows the connection member 450 to move forward or backward in a longitudinal direction of the screw shaft 440.

In addition, a rear end portion of the piston 420 is fixed to the connection member 450. Accordingly, the piston 420 fixedly coupled to the connection member 450 moves forward and backward with the connection member 450 according to the normal and reverse rotation of the screw shaft 440.

In addition, the stopper 470 is fixedly coupled to an outer side of a deceleration casing 401 protecting the decelerator. The stopper 470 is formed to restrict movement of the connection member 450 which moves to a depressurization position P3.

The stopper 470 may include a fixed member 471 and a flange member 472.

One end portion of the fixed member 471 is coupled to the deceleration casing 401, and a hollow hole into which an end portion of the guide shaft 460 is inserted is formed at a center of the fixed member 471.

In addition, the flange member 472 protrudes outward from the other end portion of the fixed member 471, and in a case in which the piston 420 moves to the depressurization position P3, the flange member 472 prevents the piston 420 from moving backward from the depressurization position P3.

An elastic member (not shown) such as rubber may also be further provided on a front surface of the flange member 472. The elastic member is formed to minimize contact impacts against the connection member 450.

FIGS. 5 to 7 show the piston 420 positioned at a first position P1, a second position P2, and the depressurization position P3, FIG. 8 shows the position detector 600 configured to detect a position of the piston 420, and a flow of a lubricant according to movement of the piston 420 will be described with reference to FIGS. 5 to 8.

Referring to FIGS. 5 to 8, in a case in which the piston 420 positioned at the depressurization position P3 moves to the first position P1, a lubricant accommodated in the temporary storage path 320 is supplied to the discharge path 330 due to the piston 420.

In addition, in a case in which the piston 420 positioned at the first position P1 moves backward to the second position P2, a lubricant accommodated in the suction path 310 is introduced into the temporary storage path 320.

In addition, in a case in which the piston 420 positioned at the second position P2 moves forward to the first position P1, the lubricant accommodated in the temporary storage path 320 is supplied to the discharge path 330.

As described above, in a lubricant supply mode in which the piston 420 repeatedly reciprocates between the first position P1 and the second position P2, the lubricant accommodated in the suction path 310 may be finally supplied to the discharge path 330 through the temporary storage path 320. That is, a lubricant accommodated in the tank 110 may be supplied to the lubricant path W due to an operation of the lubricant supply controller 400.

In this case, a predetermined idle time may be set to the motor 430 which provides power for moving the piston 420. For example, the idle time of the motor 430 may also be set to 0.1 to 1.0 seconds.

Accordingly, when normal and reverse rotation of the motor 430 is repeatedly switched, the motor 430 stops during the predetermined idle time. This is to reduce a load of the motor 430 and prevent failure occurrence of the motor 430 by preventing sudden rotation switching of the motor 430.

In addition, in a case in which the lubricant supply controller 400 operates in the lubricant supply mode, since a lubricant is continuously suppled to the lubricant path W, an internal pressure of the lubricant path W may be raised.

Accordingly, the pressure detector 500 is formed to check the internal pressure of the lubricant path W.

The pressure detector 500 may be provided at one side of the discharge path 330 and measure an internal pressure of the discharge path 330 connected to the lubricant path W so that a state of the internal pressure of the lubricant path W can be checked.

In this case, in a case in which the internal pressure of the discharge path 330 measured by the pressure detector 500 is a predetermined pressure value or more, the pressure detector 500 provides corresponding pressure measurement information to the controller 700.

Meanwhile, in a case in which the pressure measurement information transmitted from the pressure detector 500 has a predetermined pressure value or more, the controller 700 switches the lubricant supply controller 400 to a lubricant depressurization mode.

As described above, in a case in which the lubricant supply controller 400 is switched to the lubricant depressurization mode by the controller 700, a lubricant accommodated in the discharge path 330 may be guided to the suction path 310 through the bypath 340 to lower a pressure in the lubricant path W.

Specifically, when the lubricant supply controller 400 is switched to the lubricant depressurization mode from the lubricant supply mode, the lubricant supply controller 400 moves the piston 420 positioned at the first position P1 backward so that the piston 420 is moved to the predetermined depressurization position P3.

As described above, in a state in which the piston 420 is moved to the depressurization position P3, the bypath 340 is opened. That is, a first pressure relief path 341 through which the suction path 310 communicates with the cylinder 410 may communicate with a second pressure relief path 342 through which the discharge path 330 communicates with the cylinder 410.

Accordingly, a lubricant accommodated in the discharge path 330 may be guided to the suction path 310 after passing through the second pressure relief path 342, a space 411 formed between a groove 421 formed in the piston 420 and a hollow formed in the cylinder 410, and the first pressure relief path 341.

As described above, the controller 700 may selectively control an operation of the lubricant supply controller 400. In other words, the controller 700 may also operate the lubricant supply controller 400 in the lubricant supply mode or the lubricant depressurization mode. Meanwhile, the position detector 600 is formed to detect a position of the piston 420.

The position detector 600 may check the position of the piston 420 by detecting a magnet 451 provided in the connection member 450.

The position detector 600 may be a substrate, and a first detector 610 and a second detector 620 may be provided on the position detector 600. In this case, the first detector 610 and the second detector 620 may be Hall sensors configured to detect the magnet 451 installed in the connection member 450.

The position detector 600 may detect the piston 420 positioned at the first position P1 or the second position P2 through movement of the magnet 451 provided in the connection member 450 moving with the piston 420. That is, the first detector 610 may detect a state in which the piston 420 is positioned at the first position P1, and the second detector 620 may detect a state in which the piston 420 is positioned at the second position P2.

In this case, the first detector 610 and the second detector 620 configured to detect a position of the piston 420 may be elements integrally coupled to the position detector 600. The first detector 610 and the second detector 620 are disposed to be spaced apart from each other by a predetermined first distance D1.

Meanwhile, in the lubricant depressurization mode, the controller 700 moves the piston 420 positioned at the first position P1 to the depressurization position P3. In this case, the controller 700 controls the motor 430 such that the piston 420 is moved at a speed lower than a movement speed of the piston 420 in the lubricant supply mode. This is to more precisely control movement of the piston 420.

In addition, the controller 700 calculates a movement time of the piston 420 moving from the first position P1 to the second position P2. In this case, position information of the piston 420 moving from the first position P1 to the second position P2 may be checked using the first detector 610 and the second detector 620.

In this case, the controller 700 may derive a movement speed of the piston 420 on the basis of the movement time of the piston 420 moving from the first position P1 to the second position P2.

In addition, the controller 700 calculates a movement time of the piston 420 to the depressurization position P3, to which the piston 420 should reach, on the basis of the movement speed of the piston 420 to precisely control movement of the piston 420.

In this case, a second distance D2 from the second position P2 to the depressurization position P3 may be variously provided according to a specification of the lubricant pump device 1000, and the controller 700 may selectively move the piston 420 to the depressurization position P3 on the basis of information about the input second distance D2 from the second position P2 to the depressurization position P3 of the corresponding product.

As described above, since a third detector configured to detect a depressurization position P3 of a conventional piston 420 is not provided in the position detector 600 according to the present invention, for example, even when the depressurization position P3 is finely adjusted due to a change in size and structure of the lubricant pump device 1000, the piston 420 can be simply moved to the adjusted depressurization position P3 by the controller 700. The position detector 600 may be applied to various products having different specifications of the lubricant pump device 1000.

The controller 700 configured to control movement of the piston 420 may include a first storage 710, a second storage 720, and an operation part 730.

In this case, the first storage 710 stores the first distance D1 between the first detector 610 and the second detector 620.

In addition, the second storage 720 stores the second distance D2 between the second detector 620 and the depressurization position P3. In this case, the second distance D2 is provided to be selectively adjustable by a user. That is, the user can selectively input the second distance D2 according to a specification of the lubricant pump device 1000.

In addition, the operation part 730 is formed to calculate a movement time and a movement speed of the piston 420. The operation part 730 may selectively control movement of the piston 420 using various kinds of information provided from the first storage 710, the second storage 720, the first detector 610, and the second detector 620.

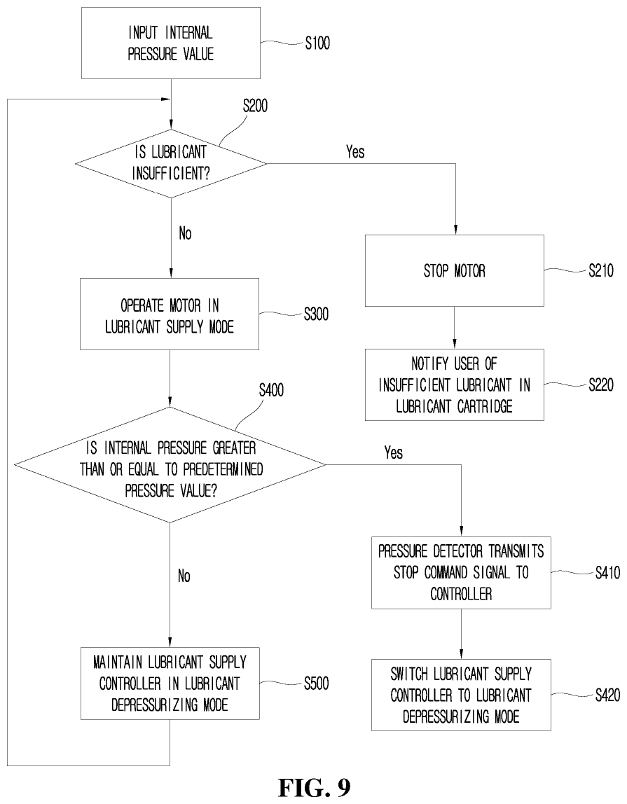

FIG. 9 is a flowchart illustrating an operation process of the lubricant pump device according to one embodiment of the present invention.

An operation process of the lubricant pump device 1000 will be described with reference to FIG. 9.

First, the lubricant pump device 1000 inputs an internal pressure value (S100).

In this case, the internal pressure value may be a pressure value of the pressure detector 500 configured to measure an internal pressure of the discharge path 330.

The internal pressure of the lubricant pump device 1000 may be set by the user but may be set to a specific pressure according to internal properties of the pump body 200.

Next, an amount of lubricant in the lubricant cartridge 100 is checked (S200).

That is, since the lubricant pump device 1000 may not be driven in a case in which the lubricant accommodated in the lubricant cartridge 100 is not sufficient when compared to a preset amount of lubricant, whether the lubricant accommodated in the lubricant cartridge 100 is sufficient is checked. The amount of lubricant accommodated in the lubricant cartridge 100 may be measured by a sensor.

In this case, in a case in which the lubricant in the lubricant cartridge 100 is insufficient, the controller 700 automatically stops the motor 430 (S210).

In addition, the controller 700 may also notify a user of information that the lubricant in the lubricant cartridge 100 is insufficient using an alarm or warning sound or transmit the corresponding information to a terminal of the user (S220).

Next, in a case in which the lubricant in the lubricant cartridge 100 is not sufficient, the controller 700 operates the motor 430 in the lubricant supply mode (S300).

In this case, the controller 700 moves the piston 420 to the first position P1 by normally rotating the motor 430.

Next, the controller 700 causes the piston 420 to reciprocate between the first position P1 and the second position P2 to supply the lubricant to the lubricant path W. That is, the controller 700 operates the lubricant supply controller 400 in the lubricant supply mode.

Next, the pressure detector 500 measures an internal pressure of the discharge path 330 (S400).

In this case, in a case in which the internal pressure of the discharge path 330 measured by the pressure detector 500 is less than a predetermined pressure value, the controller 700 maintains the lubricant supply mode (S500).

Alternatively, in a case in which the internal pressure of the discharge path 330 measured by the pressure detector 500 is a predetermined pressure value or more, the pressure detector 500 transmits corresponding information to the controller 700 (S410).

That is, in the case in which the transmitted internal pressure of the discharge path 330 measured by the pressure detector 500 is the predetermined pressure value or more, the pressure detector 500 transmits a stop command signal to the controller 700.

Next, when the controller 700 receives the stop command signal from the pressure detector 500, the controller 700 switches the lubricant supply controller 400 to the lubricant depressurization mode (S420).

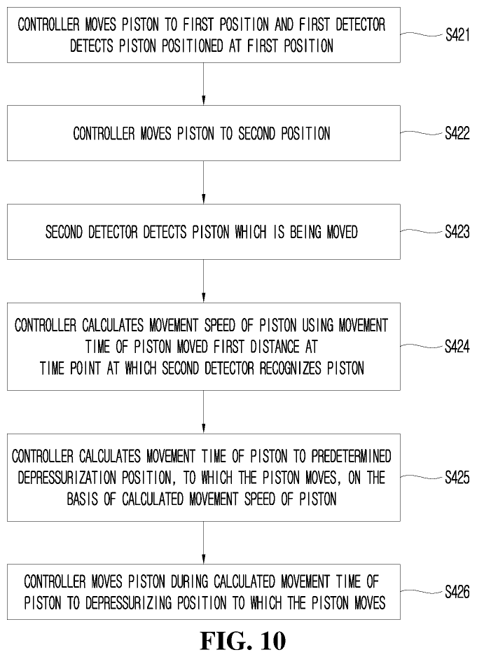

FIG. 10 is a flowchart illustrating an operation process in which the lubricant supply controller is switched to the depressurization mode according to one embodiment of the present invention.

Referring to FIG. 10, in a case in which the controller 700 is switched to the lubricant depressurization mode from the lubricant supply mode, first, the controller 700 moves the piston 420 to the first position P1, and the first detector 610 detects the piston 420 positioned at the first position (S421).

Next, the controller 700 moves the piston 420 to the second position P2 (S422). In this case, in the lubricant depressurization mode, the piston 420 may be moved at a movement speed less than a movement speed of the piston 420 in the lubricant supply mode.

Next, the second detector 620 detects the piston 420 which is moving (S423). Next, the controller 700 calculates a movement speed of the piston 420 on the basis of a movement time of the piston 420 moving the first distance D1 at a time point at which the second detector 620 recognizes the piston 420 (S424).

Next, the controller 700 calculates a movement time of the piston 420 to the predetermined depressurization position P3, to which the piston 420 moves, on the basis of the calculated movement speed of the piston 420 (S425).

Next, the controller 700 moves the piston 420 for the calculated movement time of the piston 420 to the depressurization position P3 to which the piston 420 moves (S426).

As described above, the lubricant pump device 1000 can precisely move the piston 420 to the depressurization position P3 using the above described method even without providing a third detector.

Effects of the above-described lubricant pump device and the method of operating the same according to the present invention will be described below.

A third detector provided in a conventional position detector is not needed in a lubricant pump device according to the present invention. That is, although the third detector for stopping a motor for depressurizing a lubricant path is necessarily provided in the conventional position detector, the third detector, which is provided in the conventional position detector, is not needed in the position detector according to the present invention. Accordingly, a structure of the position detector is simple and a cost can be reduced.

Since the lubricant pump device according to the present invention calculates a section speed of a piston according to a load deviation using a linked method when a controller operates the piston to control a stop position of the piston, depressurization can be precisely controlled.

The position detector according to the present invention can be applied to various products having different specifications. That is, a movement distance of the piston moving from a second position to a depressurization position can be selectively adjusted by the controller. The position detector which does not include the third detector can be applied to various products.

Effects of the present invention are not limited to the above-described effects and should be understood to include all effects which may be inferred from the detailed description of the present invention or elements of the present invention described in the claims.

However, the above description is only one exemplary embodiment, and the scope of the present invention is not limited by the described range of the embodiment.

The above description is only exemplary, and it will be understood by those skilled in the art that the invention may be performed in other concrete forms without changing the technological scope and essential features. Therefore, the above-described embodiments should be considered as only examples in all aspects and not for purposes of limitation. For example, each component described as a single type may be realized in a distributed manner, and similarly, components that are described as being distributed may be realized in a coupled manner.

The scope of the present invention is defined by the appended claims and encompasses all modifications or alterations derived from meanings, the scope, and equivalents of the appended claims.

What is claimed is:

1. A lubricant pump device comprising:
a lubricant cartridge including a tank in which a lubricant is accommodated; and
a pump body which is coupled to the lubricant cartridge and receives the lubricant from the lubricant cartridge,
wherein the pump body includes:
a suction path into which the lubricant accommodated in the tank is introduced;
a discharge path through which the lubricant introduced from the suction path is supplied to a lubricant path;
a temporary storage path disposed between the suction path and the discharge path;
a pressure detector provided at one side of the discharge path and configured to measure an internal pressure of the discharge path;
a lubricant supply controller including a cylinder communicating with the temporary storage path and a piston accommodated in the cylinder and moved forward and backward in a longitudinal direction of the cylinder;
a controller configured to control an operation in a lubricant supply mode in which the lubricant of the suction path is guided to the discharge path and configured to control an operation in a lubricant depressurization mode in which the lubricant of the discharge path is guided to the suction path through a bypath; and
a position detector including a first detector for detecting a first position of the piston to supply a lubricant accommodated in the temporary storage path to the discharge path and a second detector configured to detect a second position of the piston moved backward from the first position to introduce the lubricant accommodated in the suction path into the temporary storage path, and
the controller derives a movement speed of the piston on the basis of a movement time of the piston moved from the first position to the second position in the lubricant depressurization mode and calculates a movement time of the piston to a depressurization position, to which the piston should reach, on the basis of the derived movement speed of the piston to control movement of the piston.

2. The lubricant pump device of claim 1, wherein the controller includes:
a first storage in which information about a first distance between the first detector and the second detector is stored;
a second storage in which information about a second distance between the second detector and the depressurization position is stored; and
an operation part configured to calculate the movement time and the movement speed of the piston,
wherein the second distance is selectively adjustable by a user.

3. The lubricant pump device of claim 1, wherein the controller controls the lubricant supply controller in the lubricant depressurization mode in a case in which an internal pressure of the discharge path transmitted from the pressure detector is a predetermined pressure value or more.

4. The lubricant pump device of claim 1, wherein the lubricant supply controller further includes:
a motor which is normally and reversely rotatable;
a decelerator which decreases a rotational speed transmitted from the motor;
a screw shaft which receives power from the decelerator and is rotated;
a connection member fixed to a rear end portion of the piston and moving the piston forward and backward according to rotation of the screw shaft; and
a guide shaft formed to be parallel to the screw shaft and configured to guide a movement direction of the connection member.

5. The lubricant pump device of claim 4, further comprising a stopper fixedly coupled to an outer side of a deceleration casing protecting the decelerator and configured to restrict movement of the connection member,
wherein the stopper includes:
a fixed member which has one end portion coupled to the deceleration casing and in which a hollow hole into which an end portion of the guide shaft is inserted is formed; and
a flange member protruding outward from the other end portion of the fixed member.

6. The lubricant pump device of claim 1, further comprising:
an inlet check valve disposed between the suction path and the temporary storage path; and
an outlet check valve disposed between the temporary storage path and the discharge path,
wherein the bypath includes a first pressure relief path through which the suction path communicates with the cylinder and a second pressure relief path through which the discharge path communicates with the cylinder.

7. A method of operating a lubricant pump device, comprising the steps of:
(A) in a case in which an internal pressure of a discharge path, which is transmitted from a pressure detector, is a predetermined pressure value or more, transmitting a stop command signal from the pressure detector to a controller; and
(B) when the controller receives the stop command signal from the pressure detector, controlling a lubricant supply controller to a lubricant depressurization mode.

8. The method of claim 7, wherein the step (B) includes the steps of:
(B1) detecting, by a first detector, a piston at a first position;
(B2) moving the piston to a second position;
(B3) detecting, by a second detector, the piston which is being moved;
(B4) calculating a movement speed of the piston using a movement time of the piston moved a first distance at a time point at which the second detector recognizes the piston;
(B5) calculating a movement time of the piston to a predetermined depressurization position, to which the piston moves, on the basis of the calculated movement speed of the piston; and
(B6) moving the piston for the calculated movement time of the piston to the depressurization position to which the piston reaches.

9. The method of claim 8, wherein a distance from the second detector to the depressurization position is selectively adjustable by a user.

10. The method of claim 8, wherein, in the lubricant depressurization mode, the movement speed of the piston is less than a movement speed of the piston in a lubricant supply mode.
